(19) United States
(12) Patent Application Publication
(10) Pub. No.: US 2026/0032344 A1
(43) Pub. Date: Jan. 29, 2026

(54) IMAGE CAPTURE APPARATUS AND CONTROL METHOD THEREOF

(71) Applicant: CANON KABUSHIKI KAISHA, Tokyo (JP)

(72) Inventors: TORU MATSUMOTO, Kanagawa (JP); SHIMPEI ITAGAKI, Tokyo (JP); NAOKI NOMURA, Kanagawa (JP); TAMAKI NEGISHI, Tokyo (JP); MAI NAKABAYASHI, Kanagawa (JP)

(21) Appl. No.: 19/272,224

(22) Filed: Jul. 17, 2025

(30) Foreign Application Priority Data
Jul. 29, 2024 (JP) 2024-122549

(51) Int. Cl. H04N 23/69; H04N 23/54; H04N 23/55; H04N 23/67; H04N 25/615

(52) U.S. Cl. CPC H04N 23/69; H04N 23/54; H04N 23/55; H04N 23/672; H04N 25/6153

(57) ABSTRACT

Disclosed is an image capture apparatus that comprises first and second movable components that are movable in a direction orthogonal to an optical axis of an imaging optical system, and are located in an optical path. The image capture apparatus further comprises first driving circuitry that moves the first movable component and second driving circuitry that moves the second movable component. The image capture apparatus controls the first driving circuitry and the second driving circuitry so as to achieve a pseudo optical low-pass filter function by cyclically moving the first movable component and the second movable component in the direction orthogonal to the optical axis.

### BACKGROUND

### Field of the Technology

The present disclosure relates to an image capture apparatus and a control method thereof.

### Description of the Related Art

An image sensor including a pixel array in which a plurality of pixels are two-dimensionally arranged typically has an optical low-pass filter disposed on the subject side from an imaging plane for preventing color fringing and moiré.

On the other hand, a technique for achieving an effect (hereinafter referred to as “LPF effect”) that equivalent to an optical low-pass filter by using other methods has also been proposed. Japanese Patent Laid-Open No. 2019-220993 achieves the same effect as an optical low-pass filter by driving an image sensor so as to depict a circular trajectory in a plane orthogonal to any optical axis during exposure.

According to Japanese Patent Laid-Open No. 2019-220993, the magnitude of the LPF effect is controlled by adjusting the radius of the driving circular trajectory. However, the range of the adjustable LPF effect is limited by the driving capability of the image sensor.

### SUMMARY

In some embodiments according to the present disclosure, there are provided an image capture apparatus capable of more flexibly controlling an optical low-pass filter effect that can be achieved without using an optical low-pass filter, and a control method thereof.

According to an aspect of the present disclosure, there is provided an image capture apparatus comprising: a first movable component and a second movable component that are movable in a direction orthogonal to an optical axis of an imaging optical system, and are located in an optical path; first driving circuitry that moves the first movable component; second driving circuitry that moves the second movable component; and one or more processors that execute a program stored in a memory and thereby function as a control unit configured to control operations of the first driving circuitry and the second driving circuitry, wherein the control unit controls the first driving circuitry and the second driving circuitry so as to achieve a pseudo optical low-pass filter function by cyclically moving the first movable component and the second movable component in the direction orthogonal to the optical axis.

According to another aspect of the present disclosure, there is provided a control method of an image capture apparatus including: a first movable component and a second movable component that are movable in a direction orthogonal to an optical axis of an imaging optical system, and are located in an optical path; first driving circuitry configured to move the first movable component; and second driving circuitry configured to move the second movable component, the control method comprising controlling the first driving circuitry and the second driving circuitry so as to achieve a pseudo optical low-pass filter function by cyclically moving the first movable component and the second movable component in the direction orthogonal to the optical axis.

According to a further aspect of the present disclosure, there is provided a non-transitory computer-readable medium storing a program for causing a computer included in an image capture apparatus to perform a control method of the image capture apparatus, wherein the image capture apparatus including: a first movable component and a second movable component that are movable in a direction orthogonal to an optical axis of an imaging optical system, and are located in an optical path; first driving circuitry configured to move the first movable component; and second driving circuitry configured to move the second movable component, and wherein the control method comprising: controlling the first driving circuitry and the second driving circuitry so as to achieve a pseudo optical low-pass filter function by cyclically moving the first movable component and the second movable component in the direction orthogonal to the optical axis.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1A is a vertical sectional view of a digital camera according to an embodiment.

FIG. 1B is a block diagram showing an example of a functional configuration of the digital camera according to the embodiment.

FIG. 2A is a diagram showing an example of the temporal change in the light beam incident position caused by LPF driving.

FIG. 2B is a diagram showing an example of the response to the spatial frequency caused by LPF driving.

FIG. 3 is a diagram showing an example of LPF driving according to the embodiment.

FIG. 4 is a diagram showing another example of LPF driving according to the embodiment.

FIG. 5 is a diagram showing an example of the temporal change in the light beam incident position that can be achieved by LPF driving according to the embodiment.

FIG. 6 is a flowchart relating to an example of phase alignment for driving timings according to the embodiment.

FIG. 7 is a diagram showing an example of the frequency response of a movable component used for LPF driving.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

Note that the following describes a case where an embodiment according to the present disclosure is implemented in a digital camera. However, the embodiment according to the present disclosure can be implemented in any electronic device having an imaging function. Such electronic devices include a video camera, a computer device (a personal computer, a tablet computer, a media player, a PDA, etc.), a smartphone, a game console, a robot, a drone, and a drive recorder. However, these are merely examples, and the embodiment according to the present disclosure can also be implemented in other electronic devices.

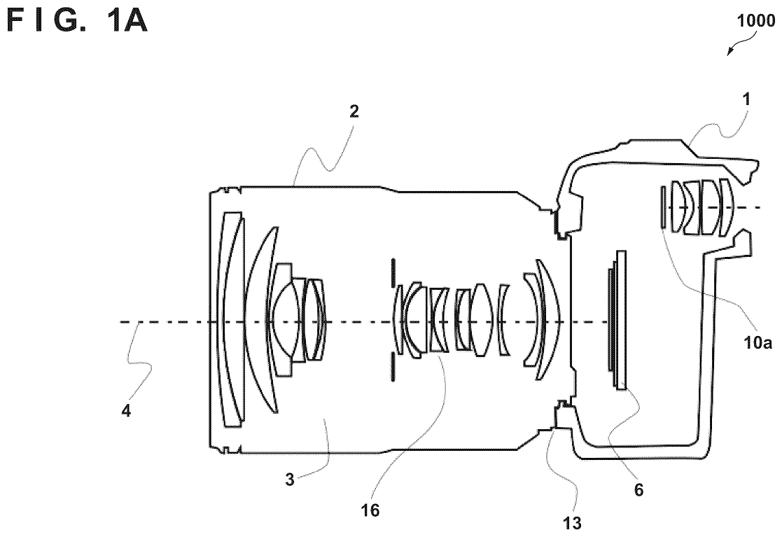

FIG. 1A is a vertical sectional view of a digital camera 1000 (hereinafter simply referred to as a “camera 1000”). Here, a vertical section including an optical axis 4 of an imaging optical system 3 is shown.

The camera 1000 is composed of a camera body 1, and a lens unit 2 that is attachable to and detachable from the camera body 1. The camera body 1 and the lens unit 2 are able to communicate with each other via an electric contact 13 configured to come into contact therewith upon mounting the lens unit 2 to the camera body 1. The electric contact 13 is also used to supply the power necessary for the operations of a circuit and the like within the lens unit 2 from the camera body 1 to the lens unit 2. Note that the lens unit 2 may be fixed to the camera body 1.

The camera body 1 includes an image sensor 6 that converts a subject optical image formed by the imaging optical system 3 into an electric pixel signal through photoelectric conversion processing. In addition, the camera body 1 includes a peephole type electronic viewfinder (EVF) 10a. The EVF 10a includes a display apparatus such as an LCD, and a finder optical system for enlarging a display screen of the display apparatus. Although not shown in FIG. 1A, the camera body 1 may include a display apparatus provided on the surface of a casing.

The lens unit 2 is formed as a so-called interchangeable lens. The lens unit 2 includes an imaging optical system 3 that forms a subject optical image. The imaging optical system 3 may include a plurality of movable lenses such as a focus lens, an image stabilization lens 16, and a zoom lens. Reference numeral 4 denotes the optical axis of the imaging optical system 3. Among the movable lenses, the image stabilization lens 16 is movable in a direction orthogonal to the optical axis 4, and the focus lens and the zoom lens are movable in a direction extending along the optical axis 4. The movable lenses are driven by a motor, an actuator, and the like that are included in the lens unit 2. The positions of the movable lenses in their movable directions can be detected with, for example, a sensor or the like included in the lens unit 2.

FIG. 1B is a block diagram showing an example of a functional configuration of the camera 1000. Except for portions (e.g., a memory 8, a display apparatus 10, an electric contact 13, etc.) that can be clearly achieved with hardware alone, the functional blocks shown in FIG. 1B can each be implemented by software, or a combination of software and hardware. For example, the functional blocks may each be achieved with dedicated hardware such as an ASIC. Also, the functional blocks may each be achieved by a processor such as a CPU executing a program stored in a memory. Note that a plurality of functional blocks may be achieved with a common configuration (e.g., one ASIC). Hardware that achieves part of the function of a given functional block may be included in hardware that achieves another functional block.

A system control unit 5 includes, for example, a processor (a CPU, an MPU, a microprocessor, or the like) capable of executing a program, and a non-volatile memory. The system control unit 5 controls operations of the units of the camera 1000 by reading, into the memory 8, the program stored in the non-volatile memory, and executing the program using the processor, thus achieving the functions of the camera 1000. The system control unit 5 also controls the operations of the lens unit 2 by communicating with a lens control unit 14 through the electric contact 13.

The memory 8 is used as a main memory used by the processor of the system control unit 5, a buffer that temporarily stores image data, a work memory in which an image processing unit temporarily stores data being processed, and the like. Also, part of the memory 8 may be used as a video memory that stores image data displayed in the display apparatus 10.

The image sensor 6 may be a known CCD or CMOS color image sensor including a color filter based on a primary-color Bayer array, for example. The image sensor 6 includes a pixel array in which a plurality of pixels are arrayed two-dimensionally, and a peripheral circuit for reading out signals from the pixels. Each pixel includes a photoelectric conversion region, and accumulates electric charges corresponding to the amount of incident light. By reading out, from each of the pixels, a signal having a voltage corresponding to the amount of electric charges accumulated during an exposure period, a group of pixel signals (analog image signals) representing a subject image formed on an imaging plane can be obtained.

In the present embodiment, each of the pixels included in the image sensor 6 has a plurality of divided photoelectric conversion regions. A signal can be read out for each of the divided photoelectric conversion regions (subpixels). For example, when one pixel has subpixels A and B, an image signal read out from a group of subpixels A, and an image signal read out from a group of subpixels B form a parallax image pair. Accordingly, for a plurality of pixels within a focus detection region, it is possible to perform auto focus detection based on a phase-difference detection method, using the image signal read out from the group of subpixels A and the image signal read out from the group of subpixels B.

An image processing unit 7 applies predetermined image processing to an analog image signal read out from the image sensor 6, thus generating a signal and image data corresponding to the use, and obtaining and/or generating various types of information. The image processing unit 7 may be, for example, a dedicated hardware circuit such as an application specific integrated circuit (ASIC) designed to achieve a specific function. Alternatively, the image processing unit 7 may be configured to achieve a specific function by a processor such as a digital signal processor (DSP) of a graphics processing unit (GPU) executing software. The image processing unit 7 outputs the obtained or generated information and data to the system control unit 5, the memory 8, a focus detection unit 11, and the like according to the use.

The image processing applied by the image processing unit 7 can include, for example, pre-processing, color interpolation processing, correction processing, detection processing, data processing, evaluation value calculation processing, special effects processing, and so forth.

Pre-processing can include A/D conversion processing, signal amplification, reference level adjustment, defective pixel correction, and so forth.

Color interpolation processing is performed in a case where the image sensor 6 is provided with a color filter, and is processing for interpolating the values of color components not included in the individual pieces of pixel data constituting image data. Color interpolation processing is also called demosaicing.

Correction processing can include processing such as white balance adjustment, tone correction, correction (image recovery) of image degradation resulting from optical aberrations of the imaging optical system 3, correction of the influence of limb darkening of the imaging optical system 3, and color correction.

Detection processing can include detection of a feature region (e.g., a face region and a body region) and motion thereof, person recognition processing, and so forth.

Data processing can include processing such as region clipping (trimming), combining, scaling, encoding and decoding, header information generation (data file generation), and so forth. Generation of display image data and recording image data is also included in data processing.

Evaluation value calculation processing can include processing such as generation of signals and evaluation values used for auto focus detection (AF), and generation of evaluation values used for auto exposure control (AE).

Special effects processing can include processing such as application of blur effect, changing of color tone, and re-lighting.

Note that these are exemplary processing that can be applied by the image processing unit 7, and do not limit the processing applied by the image processing unit 7.

The focus detection unit 11 calculates the defocus amount of a focus detection region using AF signals generated by the image processing unit 7 based on a phase-difference detection method. The focus detection unit 11 outputs the defocus amount to the system control unit 5.

The system control unit 5 transmits, to the lens control unit 14, focus adjustment information including the defocus amount supplied from the focus detection unit 11.

A camera motion sensor 18 is a sensor that detects the motion of the camera body 1. The camera motion sensor 18 may be a combination of an acceleration sensor that detects motion along each of three orthogonal axes, and a gyrosensor that detects motion around each of the axes. The camera motion sensor 18 outputs signals representing the detected motion to the system control unit 5.

In a case where an image blur correction function of moving the image sensor 6 is enabled, the system control unit 5 generates, based on the signals obtained from the camera motion sensor 18, a movement command for the image sensor 6 for cancelling out the motion of the camera body 1. The movement command includes information indicating a movement amount for each movement direction, for example. The system control unit 5 outputs the generated movement command to the sensor driving unit 12. The sensor driving unit 12 includes a movement mechanism for moving the image sensor 6 in a plane orthogonal to the optical axis 4. The sensor driving unit 12 causes the movement mechanism to operate according to the movement command supplied from the system control unit 5, thereby moving the image sensor 6.

In a case of achieving the LPF effect by moving the image sensor 6, the system control unit 5 also generates a movement command for the image sensor 6. The movement command may include, for example, in addition to information indicating the movement amount for each movement direction, information indicating a movement cycle or a frequency. The system control unit 5 outputs, to the sensor driving unit 12, the generated movement command as an instruction to start LPF driving. The sensor driving unit 12 moves the image sensor 6 by operating the movement mechanism according to the movement command supplied from the system control unit 5.

In a case of achieving the LPF effect by moving the image stabilization lens 16, the system control unit 5 generates a movement command for the image stabilization lens 16. The movement command may include, in addition to information indicating the movement amount for each movement direction, information indicating a movement cycle or a frequency. The system control unit 5 outputs, to the lens unit 2, the generated movement command as an instruction to start LPF driving. The lens control unit 14 transfers the received instruction to start LPF driving to an image stabilization lens driving unit 15. The image stabilization lens driving unit 15 moves the image stabilization lens 16 by operating the movement mechanism according to the movement command supplied from the lens control unit 14.

Note that in a case where the driving amplitudes, and the driving cycles or the frequencies of the image sensor 6 and the image stabilization lens 16 during LPF driving are fixed, the movement command need not be included in the instruction to start LPF driving. The sensor driving unit 12 and the image stabilization lens driving unit 15 respectively move the image sensor 6 and the image stabilization lens 16 with preset driving amplitude and driving cycle or frequency.

A camera operation unit 9 is a generic term for input devices (a button, a switch, a dial, etc.) provided for a user to input various instructions to the camera 1000. The input devices constituting the camera operation unit 9 have names corresponding to the functions assigned thereto. For example, the camera operation unit 9 includes a release switch, a moving image recording switch, an image-capturing mode selection dial for selecting an image-capturing mode, a menu button, a direction key, an enter key, and so forth. The release switch is a still image recording switch, and the system control unit 5 recognizes a half-pressed state of the release switch as a capturing preparation instruction, and a fully-pressed state thereof as a capturing start instruction. In addition, the system control unit 5 recognizes pressing of the moving image recording switch in a capturing standby state as an instruction to start recording of a moving image, and recognizes pressing thereof while recording a moving image as a recording stop instruction. Note that the function assigned to the same input device may be variable. The input device may be a software button or key using a touch display. The camera operation unit 9 may include an input device corresponding to a non-contact input method such as audio input and gaze input.

The display apparatus 10 is a generic term for display apparatuses provided on the camera body 1, and includes, for example, a display apparatus included in the EVF 10a, display apparatuses provided on the back surface and the upper surface of the casing of the camera body 1. Live-view images, reproduced images, a menu screen, settings and information of the camera 1000, and so forth are displayed on the display apparatus 10.

A lens motion sensor 19 is a sensor that detects the motion of the lens unit 2. The lens motion sensor 19 may be a combination of an acceleration sensor that detects motion along each of three orthogonal axes, and a gyrosensor that detects motion around each of the axes. The lens motion sensor 19 outputs a signal representing the detected motion to the lens control unit 14.

The lens control unit 14 is, for example, a one-chip microcomputer and includes a processor (a CPU, an MPU, a microprocessor, or the like) capable of executing a program, a ROM, a RAM, a communication interface, and so forth. The lens control unit 14 obtains information about the units of the lens unit 2 and controls operations by reading a program stored in the ROM into the RAM and executing the program using the processor. In addition, in response to a request received from the system control unit 5 through communication with the system control unit 5 via the electric contact 13, the lens control unit 14 drives the focus lens, and transmits the information about the lens unit 2 to the system control unit 5.

For example, the lens control unit 14 controls a focus lens driving unit 17 based on focus adjustment information received from the system control unit 5, and moves the focus lens in the direction of the optical axis 4. In addition, the lens control unit 14 controls the image stabilization lens driving unit 15 based on driving information received from the system control unit 5, and moves the image stabilization lens 16 in a direction orthogonal to the optical axis 4.

In a case where an image blur correction function of moving the image stabilization lens 16 is enabled, the lens control unit 14 generates, based on the signal obtained from the lens motion sensor 19, a movement command for the image stabilization lens 16 for cancelling out the motion of the lens unit 2. The movement command includes, for example, information indicating a movement amount for each movement direction. The lens control unit 14 outputs the generated movement command to the image stabilization lens driving unit 15. The image stabilization lens driving unit 15 includes a movement mechanism for moving the image stabilization lens 16 in a plane orthogonal to the optical axis 4. The image stabilization lens driving unit 15 moves the image stabilization lens 16 by operating the movement mechanism according to the movement command supplied from the lens control unit 14.

In a case where an instruction to start LPF driving has been received from the system control unit 5, the lens control unit 14 transfers the instruction to the image stabilization lens driving unit 15. The image stabilization lens driving unit 15 moves the image stabilization lens 16 by operating the movement mechanism according to the start instruction transferred from the lens control unit 14.

Although each of the camera body 1 and the lens unit 2 is provided with a motion sensor here, only one of them may be provided with a motion sensor. In a case where there is one motion sensor, a signal representing motion may be supplied to both the system control unit 5 and the lens control unit 14. Alternatively, the system control unit 5 or the lens control unit 14 to which a signal is supplied from a motion sensor may generate a movement command for both the image sensor 6 and the image stabilization lens 16.

### (LPF Driving)

Next, LPF driving performed in the camera 1000 will be described. LPF driving is a function of achieving the same effect as an optical low-pass filter in a pseudo manner by cyclically moving a movable component located in an optical path, in a direction orthogonal to an optical axis of an imaging optical system, instead of using an optical low-pass filter. In the present embodiment, a movable component used for image blur correction is used for the LPF driving. Accordingly, it is not necessary to add any component dedicated to LPF driving. In the present embodiment, the image sensor 6 and the image stabilization lens 16 that are included in the camera 1000 as movable components used for image blur correction can both be used for the LPF driving.

For example, when a capturing preparation instruction for a still image (half-pressing of the release button included in the camera operation unit 9) is detected in a state in which the LPF driving is enabled, the system control unit 5 instructs the sensor driving unit 12 and the lens unit 2 to start the LPF driving.

Upon receiving the instruction to start the LPF driving, the sensor driving unit 12 starts the LPF driving of the image sensor 6. The parameters (e.g., movement directions, amplitudes, cycles) of the LPF driving may be included in the start instruction, or may be set in advance in the sensor driving unit 12.

Upon receiving the instruction to start the LPF driving from the system control unit 5, the lens control unit 14 transfers the instruction to start the LPF driving to the image stabilization lens driving unit 15. Upon receiving the instruction to start the LPF driving, the image stabilization lens driving unit 15 starts the LPF driving of the image stabilization lens 16. The parameters (e.g., movement directions, amplitudes, cycles) of the LPF driving may be included in the start instruction, or may be set in advance in the image stabilization lens driving unit 15.

Based on an image obtained by capturing performed during the LPF driving, the system control unit 5 performs capturing preparation processing including AF processing and AE processing. Upon completion of the capturing preparation processing, the system control unit 5 may instruct stopping of the LPF driving. Thereafter, when a capturing start instruction (full-pressing of the release button) is detected without the half-pressed state of the release button being cancelled, the system control unit 5 instructs the sensor driving unit 12 and the lens unit 2 to start the LPF driving. Note that the system control unit 5 need not stop the LPF driving after completion of the capturing preparation processing unless the capturing preparation instruction is cancelled.

Note that the LPF driving can be performed not only at the time of still image recording, but also at the time of moving image recording. In a case where the LPF driving is enabled, the system control unit 5 transmits an instruction to start the LPF driving to the sensor driving unit 12 and the lens unit 2 upon detection of pressing of the moving image recording switch in a capturing standby state.

Note that the LPF driving here is performed at the time of a capturing preparation operation and during an exposure period. This is mainly for the purpose of saving the power consumption. The period during which the LPF driving is performed is not particularly limited. For example, the LPF driving may be performed constantly while the camera 1000 is being operated in an image-capturing mode.

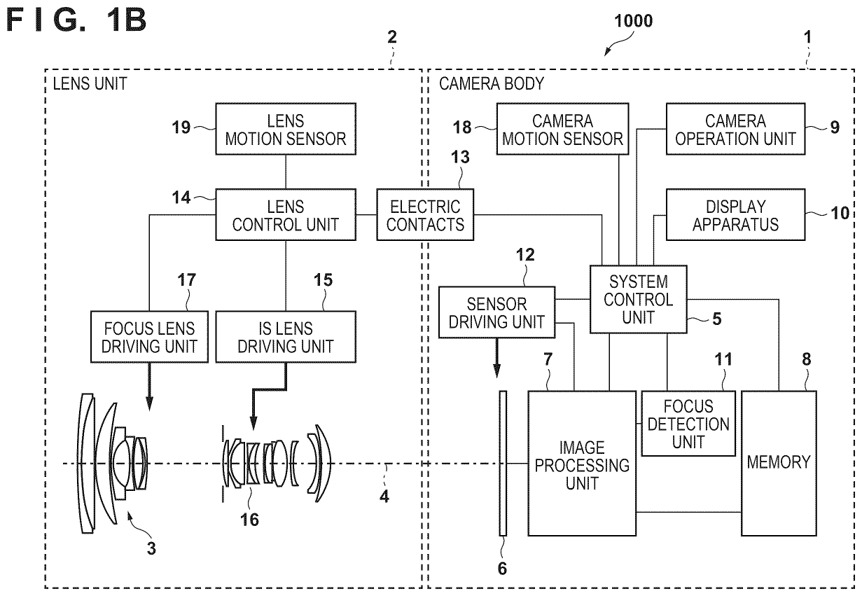

FIG. 2A is a schematic diagram showing an example of the relationship between the motion and the pixel size (or pixel pitch) of an image obtained by the LPF driving for the horizontal direction of a pixel array. The upper part shows six pixels arranged in the horizontal direction from among the pixels included in the image sensor 6. The image sensor 6 has a color filter of a primary color Bayer pattern. Here, pixels provided with green (G) and red (R) color filters arranged alternately are shown. Each pixel 6P is divided into a subpixel A and a subpixel B. GA denotes a subpixel A provided with a green color filter, and is hereinafter referred to as a “GA pixel”. RB denotes a subpixel B provided with a red color filter, and is hereinafter referred to as an “RB pixel”. The same applies to a GB pixel and an RA pixel.

The waveforms shown on the lower part indicate the temporal change in the incident position caused by the LPF driving for light beams incident on the center in the horizontal direction of the GA pixel indicated by ▾ in a state in which the LPF driving is not performed. In addition, d_{AF} denotes the pixel pitch, and T_{AF} denotes the exposure period.

The waveform indicated by the solid line shows that the cycle of change in the light beam incident position caused by the LPF driving is denoted by T_{AF}, and the amplitude is denoted by d_{AF}. The waveform indicated by the dotted line shows that the cycle of change in the light beam incident position caused by the LPF driving is denoted by T_{AF}, and the amplitude is greater than d_{AF}.

FIG. 2B is a diagram schematically showing a spatial frequency response of signals detected by the image sensor 6 with respect to the temporal change in the light beam incident position shown in FIG. 2A. The MTF characteristics of the imaging optical system 3 are also reflected on the response. The solid line and the dotted line shown in FIG. 2B correspond to the denotation of the waveforms shown in FIG. 2A.

As shown in FIG. 2B, a decrease in the amplitude of the temporal change in the incident position leads to an increase in the spatial frequency at which the response first becomes zero. This means that controlling the amplitude of the LPF driving makes it possible to control the frequency characteristics of the LPF effect achieved.

Although the effect of the LPF driving in the horizontal direction has been described here, the same description also applies to the LPF driving in the vertical direction. By performing the LPF driving such that the trajectory of the temporal change in the incident position becomes circular, it is also possible to achieve the LPF effect both in the horizontal direction and the vertical direction.

The present embodiment uses both the image sensor 6 and the image stabilization lens 16, which are movable components used for image blur correction, thereby expanding the controllable range of the amplitude of the LPF driving as compared with a case where one of the image sensor 6 and the image stabilization lens 16 is used. This is synonymous with expanding the adjustable range of the LPF effect.

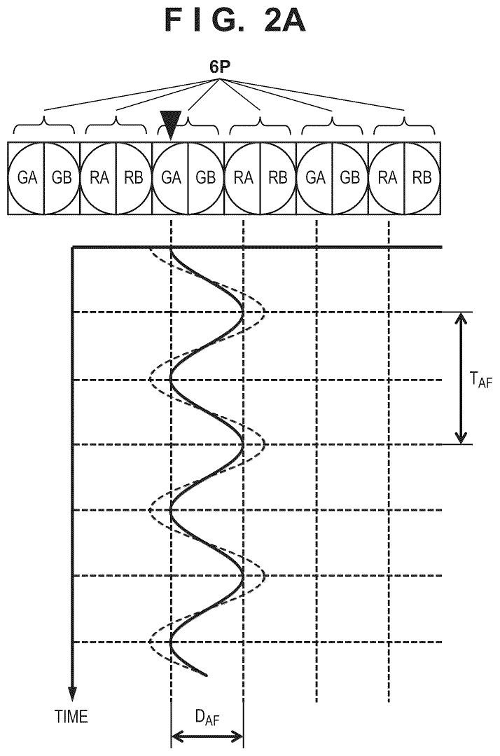

FIG. 3 is a schematic diagram for illustrating the principle of expanding the LPF effect according to the present embodiment. Reference numeral 301 shows an example of the temporal change in the light beam incident position caused by the LPF driving of the image sensor 6 in the same manner as with FIG. 2A. Similarly, reference numeral 302 shows an example of the temporal change in the light beam incident position caused by the LPF driving of the image stabilization lens 16. Here, it is assumed that the image sensor 6 is LPF-driven such that the amplitude of the temporal change in the light beam incident position is A, and the image stabilization lens 16 is LPF-driven such that the amplitude of the temporal change in the light beam incident position is B. Although a case where A and B are equal is shown as an example here, A and B may be different.

Note that the amplitude of the temporal change in the light beam incident position when the image stabilization lens 16 is LPF-driven may be different from the drive amount of the image stabilization lens 16. The reason for this is that the amplitude of the temporal change in the light beam incident position reflects not only the drive amount of the image stabilization lens, but also the magnification of the imaging optical system 3. Although not described in detail below, it is assumed that the lens control unit 14 and the system control unit 5 calculate the drive amount of the image stabilization lens 16 such that the amplitude that reflects the magnification of the imaging optical system 3 is the target amplitude. Note that the magnification of the imaging optical system 3 is known as unique information of the lens unit 2, or can be obtained from the lens unit 2.

An adder 303 schematically shows an operation for combining 301 and 302. Reference numeral 304 shows an example of the temporal change in the light beam incident position in a case where the LPF driving of the image sensor 6 shown in 301 and the LPF driving of the image stabilization lens 16 shown in 302 are performed in parallel.

Here, the temporal change 301 in the light beam incident position caused by the LPF driving of the image sensor 6, and the temporal change 302 in the light beam incident position caused by the LPF driving of the image stabilization lens 16 are synchronized (phase difference θ is 0). Accordingly, an amplitude C of the temporal change in the light beam incident position shown in 304 is equal to the sum of A and B.

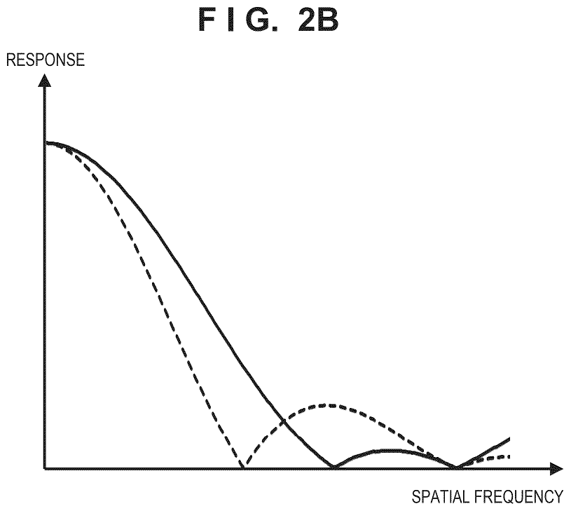

FIG. 4 is a schematic diagram for illustrating the principle of reducing the LPF effect according to the present embodiment. Reference numeral 401 shows an example of the temporal change in the light beam incident position caused by the LPF driving of the image sensor 6 in the same manner as with FIG. 3. Similarly, reference numeral 402 shows an example of the temporal change in the light beam incident position caused by the LPF driving of the image stabilization lens 16. Although it is assumed here that the image sensor 6 and the image stabilization lens 16 are LPF-driven such that the amplitudes of the temporal change in the light beam incident position are A, the amplitudes need not be equal.

An adder 403 schematically shows an operation for combining 401 and 402. Reference numeral 404 shows an example of the temporal change in the light beam incident position in a case where the LPF driving of the image sensor 6 shown in 401 and the LPF driving of the image stabilization lens 16 shown in 402 are performed in parallel.

Here, it is assumed that, where t is time, a light beam incident position D caused by the LPF driving is represented by Expression (1) below:

$$D = A sin ( 2 π * t / {T}_{AF} ) \qquad ( 1 )$$

If a phase difference θ between the temporal change 401 in the light beam incident position caused by the LPF driving of the image sensor 6 and the temporal change 402 in the light beam incident position caused by the LPF driving of the image stabilization lens 16 is not 0, Expression (1) is as follows:

$$D = A sin ( 2 π * t / {T}_{AF} - θ ) \qquad {( 1 )}^{′}$$

Accordingly, if the phase difference between 401 and 402 is not 0, the light beam incident position D in a case where the LPF driving of the image sensor 6 shown in 401 and the LPF driving of the image stabilization lens 16 shown in 402 are performed in parallel is represented by Expression (2):

$$D = A sin ( 2 π * t / {T}_{AF} ) + A sin ( 2 π * t / {T}_{AF} - θ ) \qquad ( 2 )$$

In FIG. 4, 402 has a phase difference of 8 π/10 with respect to 401. In this case, the amplitude of 404 (maximum absolute value of D) is smaller than A.

In this manner, by LPF-driving both the image sensor 6 and the image stabilization lens 16 such that the temporal changes in the light beam incident positions have a predetermined phase difference, it is possible to expand the controllable range of the light beam incident positions as compared with a case where one of the image sensor 6 and the image stabilization lens 16 is LPF-driven. With the LPF driving according to the present embodiment, it is possible to expand the controllable range of the light beam incident positions as compared with a case where one of the image sensor 6 and the image stabilization lens 16 is LPF-driven. Accordingly, it is possible to more flexibly control the magnitude of the LPF effect.

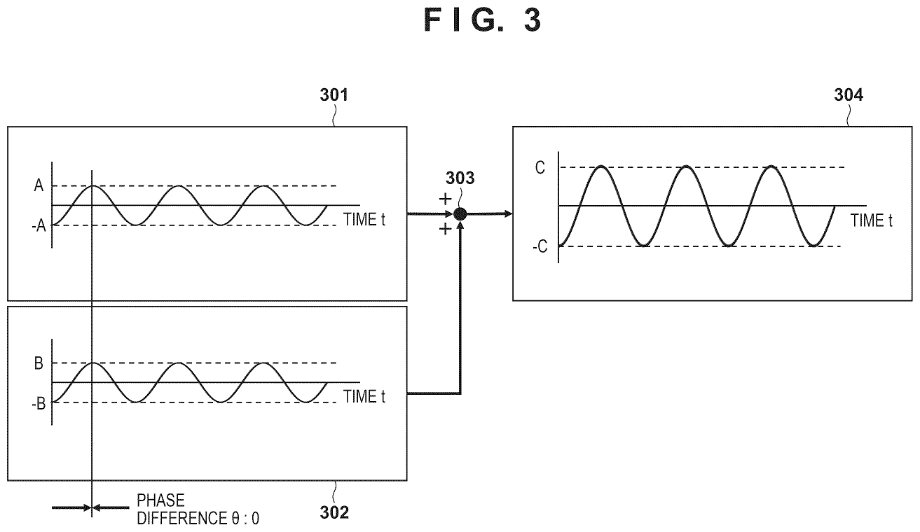

FIG. 5 shows the temporal change in the incident position D of the light beam when the value of the phase difference θ is changed under the conditions shown in FIG. 4. By changing the phase difference θ within the range from 0 to π in this manner, it is possible to continuously control the amplitude of the temporal change in the light beam incident position within the range from 0 to 2 A.

Note that the phase difference between temporal changes in the light beam incident positions can be controlled by the phase difference between the operation timings of the sensor driving unit 12 and the image stabilization lens driving unit 15. Accordingly, it can be said that the LPF driving according to the present embodiment controls the phase difference between the driving timing of the image sensor 6 by the sensor driving unit 12, and the driving timing of the image stabilization lens 16 by the image stabilization lens driving unit 15. Also, in order to control the phase difference between the driving timings, a state (the phase difference is 0) in which the driving timings of the sensor driving unit 12 and the image stabilization lens driving unit 15 are synchronized is used as a reference. In a case where the sensor driving unit 12 and the image stabilization lens driving unit 15 operate with a common clock, their operations can be synchronized based on the clock.

Alternatively, if the time difference from the instruction to start the LPF driving of the system control unit 5 until the start of the LPF driving by the sensor driving unit 12 and the image stabilization lens driving unit 15 is negligible, the operations of the sensor driving unit 12 and the image stabilization lens driving unit 15 may be considered to be synchronized. Specifically, if this time difference is, for example, less than a threshold defined based on the exposure period T_{AF}, the operations of the sensor driving unit 12 and the image stabilization lens driving unit 15 may be considered to be synchronized.

Note that, for the sake of convenience, it is assumed that the difference in delay in motion between the driven components (the image sensor 6 and the image stabilization lens 16) with respect to the control timings for the driving performed by the sensor driving unit 12 and the driving performed by the image stabilization lens driving unit 15 is negligible.

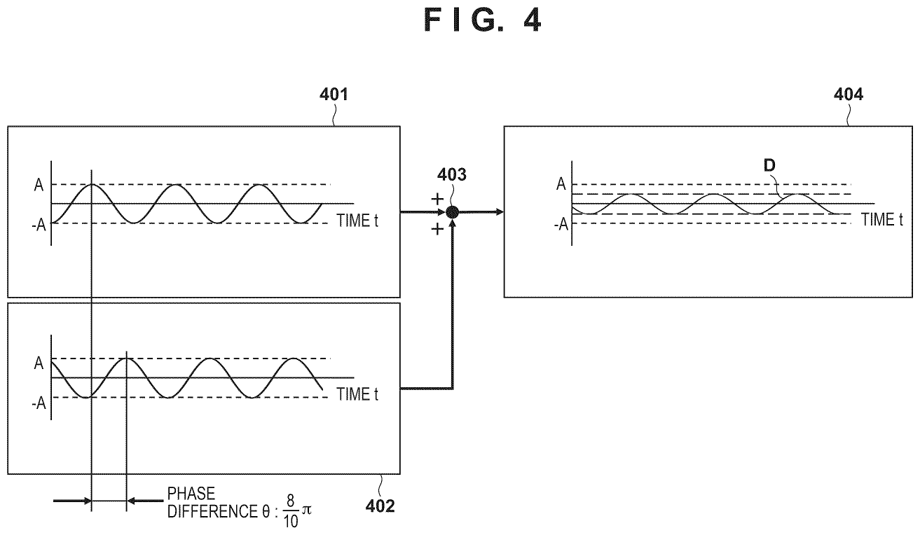

With referent to the flowchart shown in FIG. 6, another method for synchronizing the driving timings of the sensor driving unit 12 and the image stabilization lens driving unit 15 will be described. The synchronization (phase alignment) processing illustrated in FIG. 6 can be performed when the camera 1000 enters a capturing standby state after being powered up, or at any timing when a moving image can be captured and before starting the LPF driving. Note that the motion of the camera 1000 is preferably small in order to achieve accurate phase alignment. Therefore, if the magnitude of the motion of the camera body 1 that has been detected by the camera motion sensor 18 is greater than or equal to a predetermined magnitude, the system control unit 5 may display, in the display apparatus 10, a message to warn the user to bring the camera 1000 into a stationary state, or may stop the phase alignment processing.

In S2, the system control unit 5 starts the LPF driving of the image sensor 6 and the image stabilization lens 16 by outputting an instruction to start the LPF driving to the sensor driving unit 12 and the lens unit 2. In the phase alignment processing, the cycle and the amplitude of the temporal change in the light beam incident position caused by the LPF driving of the image sensor 6 and the cycle and the amplitude of the temporal change in the light beam incident position caused by the LPF driving of the image stabilization lens 16 are made equal. The system control unit 5 may include a movement command in the instruction to start the LPF driving, as needed.

The system control unit 5 changes the frame rate of a moving image captured for live-view display as needed such that the frame period of the moving image is less than the cycle of the LPF driving.

In S3, the system control unit 5 causes the image processing unit 7 to detect a motion vector between frames for the moving image captured for live-view display. The motion vector can be detected using a known method such as template matching.

In S4, based on the driving conditions of the image sensor 6 and the image stabilization lens 16, the system control unit 5 calculates an amplitude (target amplitude) to be achieved upon synchronization (phase difference 0). The target amplitude can be calculated as the sum of the amplitudes of the temporal change in the incident position achieved by the respective LPF driving.

Then, the system control unit 5 determines that the operation timings of the sensor driving unit 12 and the image stabilization lens driving unit 15 are synchronized if the magnitude of the motion vector detected in S3 is equal to the target amplitude, or is within a predetermined error range for the target amplitude.

If it is determined that the operation timings of the sensor driving unit 12 and the image stabilization lens driving unit 15 are synchronized, the system control unit 5 ends the phase alignment processing. On the other hand, if it is not determined that the operation timings of the sensor driving unit 12 and the image stabilization lens driving unit 15 are synchronized, the system control unit 5 performs S5.

In S5, the system control unit 5 generates a command instructing the operation timing of one of the sensor driving unit 12 and the image stabilization lens driving unit 15 to be advanced (or delayed) by a predetermined time (e.g., a predetermined number of clocks). Then, the system control unit 5 transmits the generated command to the sensor driving unit 12 or the lens unit 2.

When the phase alignment processing ends, the system control unit 5 restores the frame rate of capturing a moving image for live-view display. As a result of completion of the phase alignment, the above-described phase difference control for achieving the desired LPF effect can be performed.

As described in relation to FIG. 2B, it is possible to control the cutoff frequency in the LPF effect by controlling the magnitude of the amplitude of the temporal change in the light beam incident position. Accordingly, the system control unit 5 can control the phase difference between the timings of driving the image sensor 6 and the image stabilization lens 16 by the sensor driving unit 12 and the image stabilization lens driving unit 15 according to the desired cutoff frequency. Note that the correspondence between the phase difference and the cutoff frequency may be measured in advance and stored in the non-volatile memory.

The desired cutoff frequency can be determined so as to suppress the occurrence of moiré and color fringing, for example. For example, an image captured in a state in which the LPF driving is not performed is analyzed by the image processing unit 7, thereby determining a spatial frequency component that may cause moiré and color fringing. Then, the system control unit 5 can control the phase difference between the driving timings of the sensor driving unit 12 and the image stabilization lens driving unit 15 so as to achieve a cutoff frequency that removes the determined spatial frequency component.

The cutoff frequency may be set by a user via a menu screen, for example.

Alternatively, the spatial frequency that may cause moiré and color fringing is dependent on the pixel pitch of the image sensor 6, and therefore may be set as a fixed value in advance.

### (Modification 1)

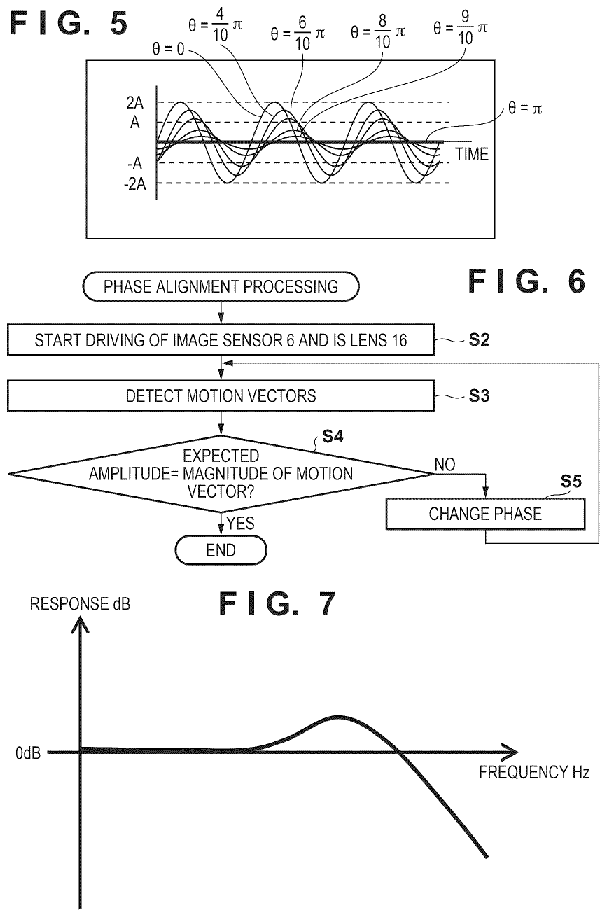

Another application example of the phase difference control for the LPF driving according to the present embodiment will be described below. FIG. 7 shows an example of the frequency response in a case where a movable component is driven. The horizontal axis represents the frequency Hz, and the vertical axis represents the response dB.

In general, the frequency response of a movable component decreases with an increase in the driving frequency. In particular, if a driving frequency is included in a segment with a response of zero dB or less (the driving frequency is greater than or equal to a frequency f), the movable component ceases to produce the intended motion.

For example, in a case where only one of the image sensor 6 and the image stabilization lens 16 is driven such that the cycle of the LPF driving is equal to the exposure period T_{AF}, it is necessary to increase the driving frequency with a decrease in the exposure period T_{AF}. However, if the driving frequency reaches for more, the desired driving amplitude cannot be achieved. In other words, if the exposure period T_{AF} is less than a threshold, the desired LPF effect cannot be achieved with one of the image sensor 6 and the image stabilization lens 16 alone. Alternatively, if the driving frequency is greater than or equal to the threshold, the desired LPF effect cannot be achieved with one of the image sensor 6 and the image stabilization lens 16 alone.

Therefore, for an exposure period T_{AF} that satisfies a condition: Exposure period T_{AF}≥Reciprocal of Driving frequency f, both the image sensor 6 and the image stabilization lens 16 are driven, and the phase difference is controlled such that the amplitude is increased.

As in the case of the controlling of the cutoff frequency, for a segment in which the driving frequency is greater than or equal to f (greater than or equal to the threshold), a phase difference for achieving the desired driving amplitude can be measured in advance, and the phase difference can be stored in the non-volatile memory. If the exposure period satisfies the above-described condition, the system control unit 5 controls the driving timings of the sensor driving unit 12 and the image stabilization lens driving unit 15 so as to have the phase difference obtained with reference to the non-volatile memory.

### (Modification 2)

Next, a case will be described where the phase difference between the LPF driving of the image sensor 6 and the LPF driving of the image stabilization lens 16 is changed between the time of focus detection and the time of capturing.

For example, during still image capturing, the exposure period is determined such that the frame rate can be maintained in a case where a moving image for live-view display is used for focus detection. On the other hand, the exposure period (shutter speed) at the time of capturing is determined based on AE processing, user settings, or the like. Accordingly, the exposure period at the time of focus detection and the exposure period at the time of capturing may be different.

If the exposure period at the time of focus detection and the exposure period at the time of capturing are different, the driving frequencies of the image sensor 6 and the image stabilization lens 16 during the LPF driving are different between the time of focus detection and the time of capturing. Therefore, the frequency responses of the image sensor 6 and the image stabilization lens 16 are also different between the time of focus detection and the time of capturing. Accordingly, an appropriate LPF effect for a captured image cannot be achieved when the phase difference between the timings of driving the image sensor 6 and the image stabilization lens 16 by the sensor driving unit 12 and the image stabilization lens driving unit 15 at the time of focus detection is used at the time of capturing.

If the exposure period at the time of focus detection and the exposure period at the time of capturing are different, the system control unit 5 causes the phase difference between the timings of driving the image sensor 6 and the image stabilization lens 16 to be different between the time of focus detection and the time of capturing such that the cutoff frequency of the LPF effect is not changed between the time of focus detection and the time of capturing.

There may be a case where the pixel pitch used is different between the time of focus detection and the time of capturing. Examples of such a case include a case where pixels each including a plurality of divided photoelectric conversion regions are discretely provided. In this case, the pixel pitch used at the time of focus detection is wider than the pixel pitch used at the time of capturing. In this case, the same LPF effect as that achieved at the time of capturing cannot be achieved unless the driving amplitude of the LPF driving at the time of focus detection is larger than that at the time of capturing.

In a case where the pixel pitch used at the time of focus detection and the pixel pitch used at the time of capturing are different, the system control unit 5 causes the phase difference between the timings of driving the image sensor 6 and the image stabilization lens 16 to be different between the time of focus detection and the time of capturing so as to achieve a driving amplitude that can achieve the same LPF effect at the time of focus detection and the time of capturing.

Note that in a case where one or more of the exposure period and the pixel pitch are different between the time of focus detection and the time of capturing, the system control unit 5 may cause not only the phase difference between the driving timing, but also the driving cycle, to be different between the time of focus detection and the time of capturing.

According to some embodiments of the present disclosure, it is possible to provide an image capture apparatus capable of more flexibly controlling the range of an optical low-pass filter effect that can be achieved without using any optical low-pass filter, and a control method thereof.

### OTHER EMBODIMENTS

In the above-described embodiment, a combination of LPF driving and image blur correction is not described in order to facilitate illustration and understanding. However, LPF driving and image blur correction can be implemented in combination. For example, the system control unit 5 may output, to the sensor driving unit 12 and the image stabilization lens driving unit 15, a movement command in which a movement amount for LPF driving and a movement amount for image blur correction are summed up. Alternatively, the system control unit 5 may output a movement command to each of the image sensor 6 and the image stabilization lens driving unit 15 such that one of the image sensor 6 and the image stabilization lens driving unit 15 handles LPF driving, and the other handles image blur correction.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-122549, filed Jul. 29, 2024, which is hereby incorporated by reference herein in its entirety.

What is claimed is:

1. An image capture apparatus comprising:
a first movable component and a second movable component that are movable in a direction orthogonal to an optical axis of an imaging optical system, and are located in an optical path;
first driving circuitry that moves the first movable component;
second driving circuitry that moves the second movable component; and
one or more processors that execute a program stored in a memory and thereby function as a control unit configured to control operations of the first driving circuitry and the second driving circuitry, wherein
the control unit controls the first driving circuitry and the second driving circuitry so as to achieve a pseudo optical low-pass filter function by cyclically moving the first movable component and the second movable component in the direction orthogonal to the optical axis.

2. The image capture apparatus according to claim 1, wherein,
in a case where a required optical low-pass filter function is unable to be achieved by moving one of the first movable component and the second movable component, the control unit controls the first driving circuitry and the second driving circuitry so as to move the first movable component and the second movable component.

3. The image capture apparatus according to claim 2, wherein
the case where the required optical low-pass filter function is unable to be achieved by moving one of the first movable component and the second movable component is a case where an exposure period is less than a threshold.

4. The image capture apparatus according to claim 2, wherein
the case where the required optical low-pass filter function is unable to be achieved by moving one of the first movable component and the second movable component is a case where a driving frequency of the one movable component becomes greater than or equal to a threshold.

5. The image capture apparatus according to claim 1, wherein,
in order to achieve a required optical low-pass filter function, the control unit controls a phase difference between a timing at which the first driving circuitry moves the first movable component, and a timing at which the second driving circuitry moves the second movable component.

6. The image capture apparatus according to claim 5, wherein
the required optical low-pass filter function is a cutoff frequency of the optical low-pass filter.

7. The image capture apparatus according to claim 6, wherein
the cutoff frequency is determined so as to remove a spatial frequency component that causes moiré or color fringing.

8. The image capture apparatus according to claim 1, wherein
the control unit performs the controlling of the first driving circuitry and the second driving circuitry at both a time of focus detection and a time of capturing during still image capturing.

9. The image capture apparatus according to claim 8, wherein,
in a case where an exposure period at the time of focus detection and an exposure period at the time of capturing are different, the control unit causes a phase difference between a timing at which the first driving circuitry moves the first movable component and a timing at which the second driving circuitry moves the second movable component to be different between the time of focus detection and the capturing.

10. The image capture apparatus according to claim 8, wherein,
in a case where a pixel pitch used at the time of focus detection and a pixel pitch used at the time of capturing are different, the control unit causes a phase difference between a timing at which the first driving circuitry moves the first movable component and a timing at which the second driving circuitry moves the second movable component to be different between the time of focus detection and the time of capturing.

11. The image capture apparatus according to claim 1, wherein
the first movable component is a movable lens included in the imaging optical system, and
the second movable component is an image sensor.

12. A control method of an image capture apparatus including:
a first movable component and a second movable component that are movable in a direction orthogonal to an optical axis of an imaging optical system, and are located in an optical path;
first driving circuitry configured to move the first movable component; and
second driving circuitry configured to move the second movable component, the control method comprising
controlling the first driving circuitry and the second driving circuitry so as to achieve a pseudo optical low-pass filter function by cyclically moving the first movable component and the second movable component in the direction orthogonal to the optical axis.

13. A non-transitory computer-readable medium storing a program for causing a computer included in an image capture apparatus to perform a control method of the image capture apparatus,
wherein the image capture apparatus including:
a first movable component and a second movable component that are movable in a direction orthogonal to an optical axis of an imaging optical system, and are located in an optical path;
first driving circuitry configured to move the first movable component; and
second driving circuitry configured to move the second movable component, and wherein the control method comprising:
controlling the first driving circuitry and the second driving circuitry so as to achieve a pseudo optical low-pass filter function by cyclically moving the first movable component and the second movable component in the direction orthogonal to the optical axis.
